(19) United States
(12) Patent Application Publication
(10) Pub. No.: US 2003/0208365 A1
(43) Pub. Date: Nov. 6, 2003

(54) On-line design of distribution transformers

(76) Inventors: Randall N Avery, Bogart, GA (US); Tarek El Hadidi, Duluth, GA (US); Guojun Zhu, Athens, GA (US); Joel Goodling, Athens, GA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/297,877

(22) PCT Filed: Dec. 27, 2000
(86) PCT No.: PCT/US00/35268

(51) Int. Cl. G06F 17/60

(52) U.S. Cl. 705/1

(57) ABSTRACT

An improved system and method for the production of transformers, such as small, simple pad mounted distribution transformers is described. An external user (101), e.g., a customer or a field sales person, is permitted to orchestrate the entire negotiation and production process (104) to meet his or her specific requirements. The user is able to submit orders, review scheduling, and receive confirmation of the manufactures of the transformer over a network (102), such as the INTERNET. In the background, the manufacturing process (106) is preferably automated (105) to minimize the cycle time and the number of people required to satisfy the user's requirements. The transformer ordering system can be integral in designing and ordering high quality distribution transformers. In a preferred embodiment, it uses interactive tools (101, 103, 105) to assure quick and knowledgeable design and ordering of distribution transformers. The transformer ordering system and method go beyond the traditional sales and manufacturing, etc. before a Request for Quote (RFQ) is generated. This system can be partnered with other design and ordering systems to provide full service ordering, or it may be a stand-alone INTERNET-based ordering system.

### FIELD OF THE INVENTION

The present invention relates in general to integrated business systems, and particularly, to an integrated business system for the on-line ordering of distribution transformers.

### BACKGROUND OF THE INVENTION

The current system for ordering electrical distribution transformers is an expensive and inefficient system. Under the current system, one or more field sales representatives meet with a customer who requires a distribution transformer to determine the customers needs. The field sales representative then relays this information to one or more internal sale representatives where the ordering information is further defined. The ordering information is then forwarded to one or more design engineers. The design engineer employs one or more draftspersons to work with the design engineer in developing the engineering design and drawings for the transformer in accordance with the customer's requirements. Numerous planning and scheduling persons develop a plan for the material acquisition and manufacture of the transformer as well as for the payment and delivery of the completed transformer. Once the design of the transformer has been completed, the design is forwarded to the manufacturing department or division where the actual construction of the transformer occurs in accordance with the engineering design and drawings. Finally, the completed transformer is shipped to the customer.

As can be appreciated, this conventional process for ordering transformers is expensive, very labor intensive, and time consuming due to the relatively large number of people involved and the numerous steps involved in the ordering process. Therefore, a need exists for a new seamless business system for the on-line ordering of transformers which is less expensive and less time consuming.

### SUMMARY OF THE INVENTION

The transformer ordering system and method can be integral in designing and ordering high quality distribution transformers. The transformer ordering system and method preferably use interactive tools to assure quick and knowledgeable design and ordering of distribution transformers. As such, the transformer ordering system and method go beyond the traditional sales and marketing, design, manufacturing, etc. before a Request For Quote (RFQ) is generated. The transformer ordering system and method can be partnered with other design and ordering systems to provide full service ordering, or, alternatively, it may be a stand-alone Internet-based ordering system.

The present invention includes a system for facilitating the on-line configuration and pricing of a distribution transformer. The on-line configuration and pricing occurs between one or more users and one or more manufacturers of transformers, preferably over a network capable of providing communications between the manufacturers and a user sites associated with each user. Each user site includes an input device and a display device for use by the user in communicating information between the user site and a system server. A web site is coupled to the server and is accessible from each user site via a network.

A database is provided for storing transformer manufacturer design data for use by the user in designing a transformer to specific design requirements and also for storing transformer pricing data for use in producing a price quotation based on a transformer design designated by the user. The database is accessible by the server.

A display means is provided on the web site for causing transformer design data of at least one manufacturer to be represented on the display device. A product configuration means is also provided on said web site for use by the user in designing a transformer by selecting transformer design data displayed by the display means using the input device to configure the transformer. A product description means is provided on said web site for displaying to the user a product description resulting from product configuration means. The product description preferably includes calculated performance characteristics and a list of mechanical and electrical features. A pricing means is also provided on said web site for calculating a price of the transformer designed by the user. The calculated price and the product description are displayed to the user via the web site.

The transformer ordering system may further include a product ordering means provided on the web site for use by the user in entering an order for the transformer using, for example, the input device after reviewing the product description and the calculated price of the transformer. The transformer order is received by the server and can be forwarded to the selected manufacturer for manufacturing of the transformer in accordance with the product description.

The database can also store customer identification information indicative of a customer's identity, location, and billing policy. This allows the user to access the customer identification information in the database via the server and make a single selection via, for example, the web site which thereby incorporates all of the customer identification information into the order.

The product configuration means can further include a form-based menu for use by the user in malting selections. The design specification data represented on the display device can further include one or more of predefined product specification data and a selection of options from a predefined set of choices that are accessible via the form-based menu using the input device. The selection of one of the predefined product specification data by the user preferably results in incorporation of all of the manufacturing design specification data into the product description and the product pricing.

The transformer ordering system preferably includes an order editing means for use by a user in changing a previously entered transformer order via the web site using the input device. In addition, the transformer ordering system preferably includes an order statusing means for use by a user in accessing the system to obtain a status of a previously entered transformer order at the display device.

The product pricing means preferably includes a cost analysis of the bill of materials, a manufacturing cost, and a suggested selling price for the transformer configured by the user.

The transformer ordering system includes a manufacturing bill of materials generated by the product configuration means. The system may also employ a shopping cart means for use by the user in adding one or more ordered items to a shopping cart on the web site. The shopping cart means preferably includes an upper level used to display general information to the user, such as for example, a price, a quantity, a product identification number, and a delivery lead-time of said designed transformer. The shopping cart means also preferably includes a lower level which is not displayed to said user, and includes, for example, a bill of materials and mechanical and electrical performance data specific to the designed transformer.

In one embodiment, the transformer ordering system further includes a drawing development means on the web site for creating drawings on the server depicting the designed transformer. Preferably, the drawings can be downloaded to the remote user site and also can be communicated to a manufacturer of the designed transformer.

The present invention is also directed to a method for creating an on-line request for quote for a distribution transformer. The method includes the steps of: providing a server accessible by a user from a remote location for receiving a request for quote from the user; receiving customer data into the server, receiving ship to information for the customer into the server, providing terms relating to terms of sale for selection by the user relating to the request for quote; providing notes relating to different stages in completing the request for vote for selection by the user for attachment to the request for quote; providing a shopping cart to which the user may add one or more items selected for the request for quote; providing a designing server accessible by the user from a remote location for designing a transformer in accordance with the request for quote; providing one or more manufacturer design specifications for use by the user in designing the transformer, generating a bill of materials and a transformer description in accordance with the request for quote for the designed transformer, calculating a manufacturing cost for the transformer based on the bill of materials; and displaying user request for quote at the remote location.

The method can further include the step of receiving an order from the user for the transformer into the server. The method can further include the step of forwarding the order for the transformer from the server to a manufacturer of transformers for manufacturing of the transformer in accordance with the bill of materials and the transformer description.

In accordance with one aspect of the method of the present invention, the request for quote received from the user may include one of a new request for quote and an existing request for quote previously entered into the server.

The method can further include the step of creating drawings on the server based of the bill of materials and a transformer description, the drawings being adapted for download to the user's remote location and for attachment to the request for quote.

In accordance with another aspect of the present invention, the step of providing a designing server accessible by a user from a remote location for designing a transformer further comprises designing and defining items according to predetermined manufacturing specifications including adding accessories and selecting a core and coil.

The step of providing a designing server may further include the steps of providing a first parts selection menu for use by the user in selecting internal accessory parts independent of the core and coil, providing a menu for selecting a coil and coil, and providing a second parts selection menu for use by the user in selecting external parts for packaging the core and coil.

The method can further include the step of storing customer data and transformer manufacturer design data in a database that is accessibly from the server for use by the user in completing the on-line request for quote for a transformer. Preferably, the method also includes the step of allowing a user to check the status of a previously submitted request for quote from a remote location.

Other features of the invention are described below.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings embodiments that are presently preferred, it being understood, however, that the invention is not limited to the specific methods and instrumentalities disclosed. In the drawings:

FIG. 1 is a schematic diagram of an exemplary on-line design and ordering system for distribution transformers;

FIG. 2 is a flowchart illustrating an exemplary negotiation and design process for the on-line design and ordering system for distribution transformers;

FIGS. 3A and 3B are flowcharts showing further details of the negotiation and design process of FIG. 2;

FIG. 4 shows an exemplary client-server system for ordering, designing, editing, and statusing a transformer order in according with the present invention;

FIG. 5 is a shows an exemplary computing environment for the on-line design of distribution transformer system in accordance with the present invention;

FIG. 6 is a screen shot of an exemplary login ID and password screen;

FIG. 7 is a screen shot of an exemplary RFQ search screen;

FIG. 8A is a screen shot of an exemplary choose a customer screen;

FIG. 8B is a screen shot of an exemplary customer search from search results screen;

FIG. 9 is a screen shot of an exemplary RFQ results screen;

FIG. 10 is a screen shot of an exemplary ship to screen;

FIG. 11 is a screen shot of an exemplary general customer information screen;

FIG. 12 is a screen shot of an exemplary customer terms screen;

FIG. 13A is a screen shot of an exemplary notes summary screen;

FIG. 13B is a screen shot of an exemplary general imported noted screen;

FIG. 14A is a screen shot of an exemplary shopping cart screen;

FIG. 14B is a screen shot of an exemplary line item screen;

FIG. 15A is a screen shot of an exemplary design specification screen;

FIG. 15B is a screen shot of an exemplary design accessories screen;

FIG. 16 is a screen shot of an exemplary ratings screen;

FIG. 17 is a screen shot of an exemplary select core and coil screen;

FIG. 18 is a screen shot of an exemplary bill of materials screen;

FIG. 19A is a screen shot of an exemplary top of published design screen;

FIG. 19B is a screen shot of an exemplary bottom of published design screen;

FIG. 20 is a screen shot of an exemplary other manufacturing specification ratings screen;

FIG. 21 is a screen shot of an exemplary maintenance screen;

FIG. 22 is a screen shot of an exemplary loss evaluation screen;

FIG. 23 is a screen shot of an exemplary core/coil selection screen;

FIG. 24 is a screen shot of an exemplary bill of material screen wherein the cost data is a hidden column; and

FIG. 25 is a screen shot of an exemplary pricing screen.

### DETAILED DESCRIPTION OF THE PREFERRED EMBODIMENTS

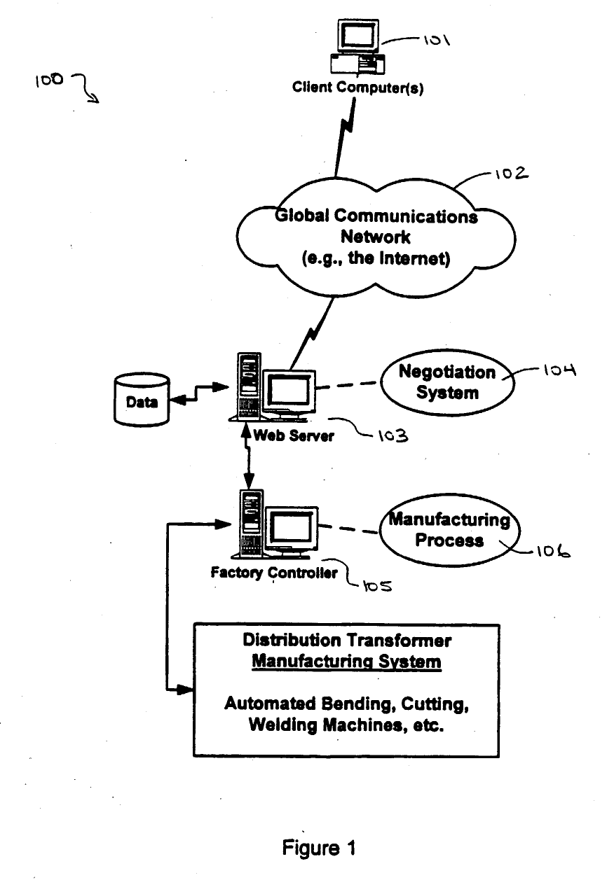

The present invention relates to a “lights out” factory for the production of transformers, such as small, simple pad mounted distribution transformers. An external user, i.e., a customer or a field sales person, is permitted to orchestrate the entire production process to meet his or her requirements. The user is able to configure the product and produce a quotation. The user is also able to submit orders, review scheduling, and receive confirmation of the manufacture of the products in a manner similar to ordering a custom made personal computer over the Internet. In the background, the manufacturing process is automated to minimize the cycle time and the number of people required to satisfy the user's requirements. The inventive system is depicted schematically in the attached FIG. 1.

The negotiation system (e.g., the transformer ordering system) 100 combines the efforts of the internal sales person, the design engineer and the drafting people with the capabilities of the Internet 102. The system presents the user at a remote location 101 with the ability to fully configure a transformer through a server 103 using a combination of a predefined product specification and a selection of options from a set of choices (i.e., a form-based menu) contained in a negotiations system 104. This product configuration process generates the entire manufacturing bill of materials. The costs associated with each item in the bill of materials is summed to a manufacturing cost, which is then used to verify the calculation of a suggested selling price. A product description is also created. The product description includes the calculated performance characteristics and a summarized list of mechanical and electrical features.

The customer is presented electronically with a finished quotation document, including an outline drawing suitable for installation purposes. From this quotation document, the customer is capable of producing an order that is transmitted into the manufacturing system, such as factory controller 105, to initiate the production of transformers in the manufacturing process 106.

The system has the usual capability of a “shopping cart” The user can add as many different items to the shopping cart as desired. Each new item is identified as a particular type of product, such as a distribution transformer. Other products may be added as well. At the shopping cart level, the system only keeps generic data such as price, quantity, product style number, and delivery lead-time. The actual bill of materials, and electrical and mechanical performance data, are stored at a lower level of product data, specific to the transformer manufacturer.

In addition, the customer may view the status of his or her order via the Internet.

I. Overview

The transformer ordering system 100 and method can be integral in designing and ordering high quality distribution transformers. The transformer ordering system 100 and method preferably use interactive tools to assure quick and knowledgeable design and ordering of distribution transformers. As such, the transformer ordering system 100 and method go beyond the traditional sales and marketing, design, manufacturing, etc. before a Request For Quote (RFQ) is generated. The transformer ordering system 100 and method can be partnered with other design and ordering systems to provide full service ordering, or, alternatively, it may be a stand-alone Internet-based ordering system. Those skilled in the art will readily appreciate that the description given herein with respect to those Figures is for explanatory purposes only and is not intended in any way to limit the scope of the invention.

The Web-based transformer ordering system of the present invention provides the information and design specifications to a central or integrated marketing-engineering server which acts as a central repository for the management of order and design information. The central marketing-engineering server may be a common portal that correlates the order and design data from the various vendors and customers, and thus facilitates negotiating, ordering, designing, marketing, statusing, and manufacturing quality distribution transformers that meet individual customer needs and specific design requirements. In particular, central marketing-engineering server may be accessed by users (e.g., customers) of the transformer ordering system 100 to improve and streamline various aspects of ordering and designing distribution transformers. In so doing, transformer ordering system 100 may assist the transformer industry in the transformation from its current focus on sales, planning, scheduling, and marketing to focus on a seamless business system resulting in a lower cost and more efficient design and distribution basis.

For purposes of clarity, the term “user,” as used herein, is intended to refer to customers of the commercial embodiment of the invention as well as salespeople, engineers, designers draftspersons, marketers, and the like. For example, where the invention is embodied in an Internet Web page format, a customer would include a visitor browsing the Web page.

Customers for transformer ordering system 100 can include, for example, electrical companies who seek improved ways to assure lower cost and improved efficiencies in ordering transformers. Power utility companies that desire to order transformers through this more cost effective and timely approach should have a presumed ordering and design advantage over competing systems. It is also anticipated that vendors themselves will become a second source of customers for the transformer ordering system 100. Once a vendor gains access to the transformer ordering system 100, he or she will have begun to differentiate themselves from their peers and competitors on the basis of their affiliation with the transformer ordering system 100.

By focusing upon on-line ordering and designing of quality transformers through a comprehensive, one-stop shopping source, the transformer ordering system 100 can provide substantial improvements in cost, efficiency, and cycle time for various customers. For example, electrical companies may benefit through lower cost and improved efficiencies in ordering transformers. Power utility companies may benefit by having the tools necessary to order transformers more cost effectively and in a more timely manner thus resulting in an ordering and design advantage over competing systems.

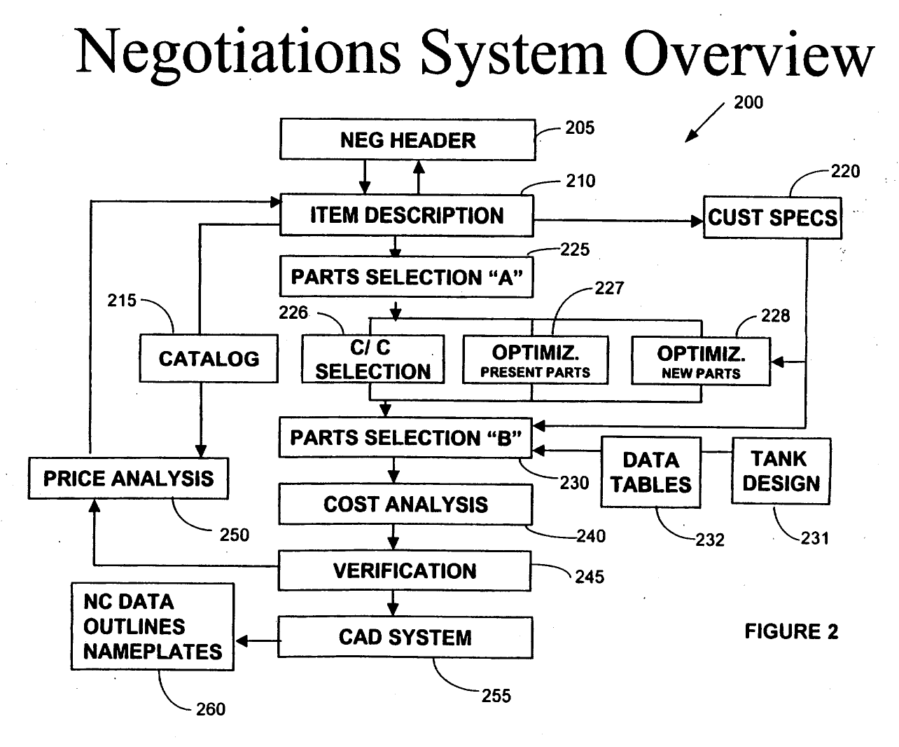

FIG. 2 is a flowchart illustrating an exemplary negotiation process 200 for building and pricing a desired transformer. As shown in FIG. 2, the negotiation process includes the steps of accessing a negotiation header, at step 205. An item description is entered at step 210. The item description step 210 can include several alternative processes for completing the negotiation process. For example, a user may access a catalog of different transformer designs, at step 215, in order to specify a desired transformer from the catalog. Alternatively, the user may access a specific custom specification for different distribution transformers, at step 220, in order to tailor the transformer to that user's specific needs. The user may then proceed to construct a bill of materials (BOM) through specific processes of Parts Selection “A”, step 225, selecting or creating a Core and Coil design, step 226, 227, or 228 and Parts Selection “B” (discussed in more detail below).

The user may also proceed from the item description (step 210) to a first parts selection, or part selection “A” step, at step 225, where the user may select an internal engineering design of the transformer. At step 226, the user may select the design for the core and coil of the transformer. At step 227, the user may optimize the engineering design with standard/present parts. At step 228, the user may optimize the engineering design with new parts.

After completing the parts selection “A” (step 225), the user proceeds to a second parts selection, or parts selection “B” step, at step 230, where the tank and other parts necessary to package the core and coil are selected. At step 231, the tank design is selected using data tables at step 232. This information is inputted into the negotiation process at parts selection “B”. Optionally, the negotiation process 200 can include an automatic tank design.

A cost and labor analysis is performed at step 240. The cost analysis is verified at step 245 and then a price analysis is performed at step 250. This price analysis information is feedback to the item description (step 210). Also, if the user had chosen to access a manufacturer's catalog, at step 215, then they would proceed from step 215 directly to the price analysis, at step 250.

Also, the user may select a drawing option, such a CAD system, to develop engineering design drawing for the transformer, at step 255. This option may also be used to prepare NC data and outlines for templates to be mounted on the transformer, at step 260.

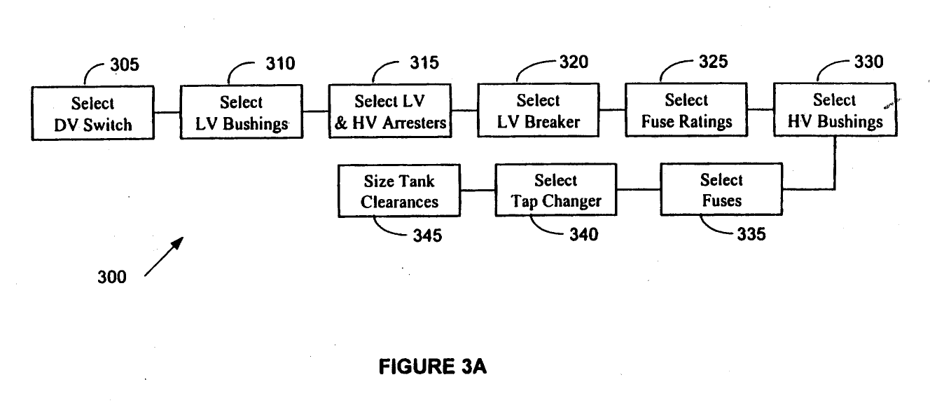

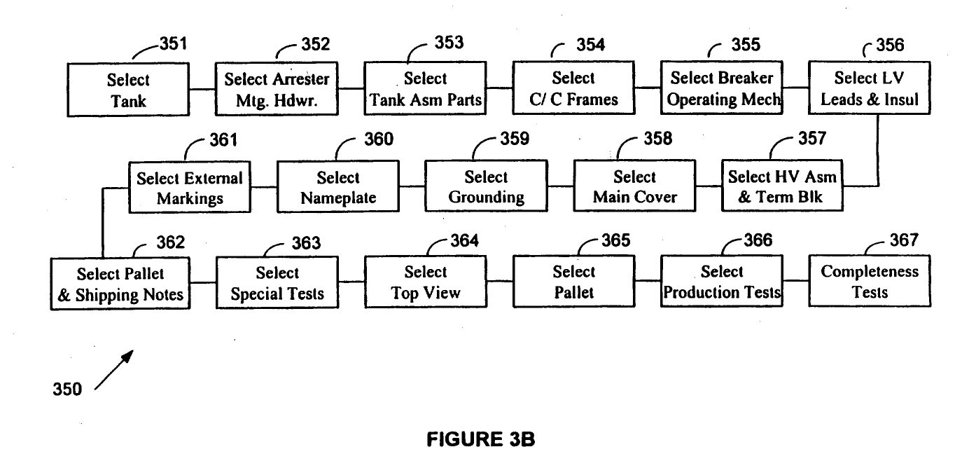

FIG. 3A is a flowchart showing further details of the first parts selection step (step 225) described above. The first part selection process 300 includes the steps for the selection of parts independent of the core and coil. The selection made during the first parts selection set minimum tank dimensions based on necessary accessories prior to the core and coil selection As shown in FIG. 3A, at step 305, the user selects a DV switch. At step 310, the user selects the LV bushings. At step 315, the user selects the LV and HV arresters. At step 320, the user selects the LV breaker. At step 325, the user selects the fuse ratings. At step 330, the user selects the HV bushings. At step 335, the user selects the fuses. At step 340, the user selects the tap changer. At step 345, the user selects the size of the tank clearances. Steps 305, 315, 320, 325, 335, and 340 are optional, and may be included to satisfy the customer specifications for the transformer. Steps 310, 330, and 345 preferably occur for each design.

FIG. 3B is a flowchart showing further details of the second parts selection step (step 230) described above. The second part selection process 350 includes the steps for the selection of parts after the core and coil and tank, thus completing the engineering design. As shown in FIG. 3B, at step 351, the user selects the tank. At step 352, the user selects the arrester mounting hardware. At step 353, the user selects the tank assembly parts. At step 354, the user selects the core and coil frames. At step 355, the user selects the breaker operating mechanism. At step 356, the user selects the LV leads and insulation. At step 357, the user selects the HV assembly and terminal blocks. At step 358, the user selects the main cover. At step 359, the user selects the grounding features and terminals. At step 360, the user selects the nameplate. At step 361, the user selects the external markings. At step 362, the user selects the pallet and shipping notes. At step 363, the user selects the special tests (if necessary). At step 364, the user selects the factory assembly drawings. At step 365, the user selects the pallet. At step 366, the user selects the production tests. At step 367, the user selects the completeness tests. Steps 352, 355, 357, and 363 are preferably optionally included in the design process.

Exemplary Operating Environment

FIGS. 1, 4, and 5, and the following discussion of those Figures is intended to provide a brief, general description of an exemplary client/server system 400 from which the transformer ordering system 100 may be accessed and also a suitable computing environment 500 in which the invention may be implemented. While the invention will be described in the general context of computer-executable instructions of a computer program that runs on a personal computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The illustrated embodiment of the invention also is practiced in distributed computing environments where tasks are performed by remote processing devices that are linked through a communications network. However, it is contemplated that the invention can be practiced on standalone computers. In a distributed computing environment, program modules may be located in both local and remote memory storage devices.

Client-Server System Interface

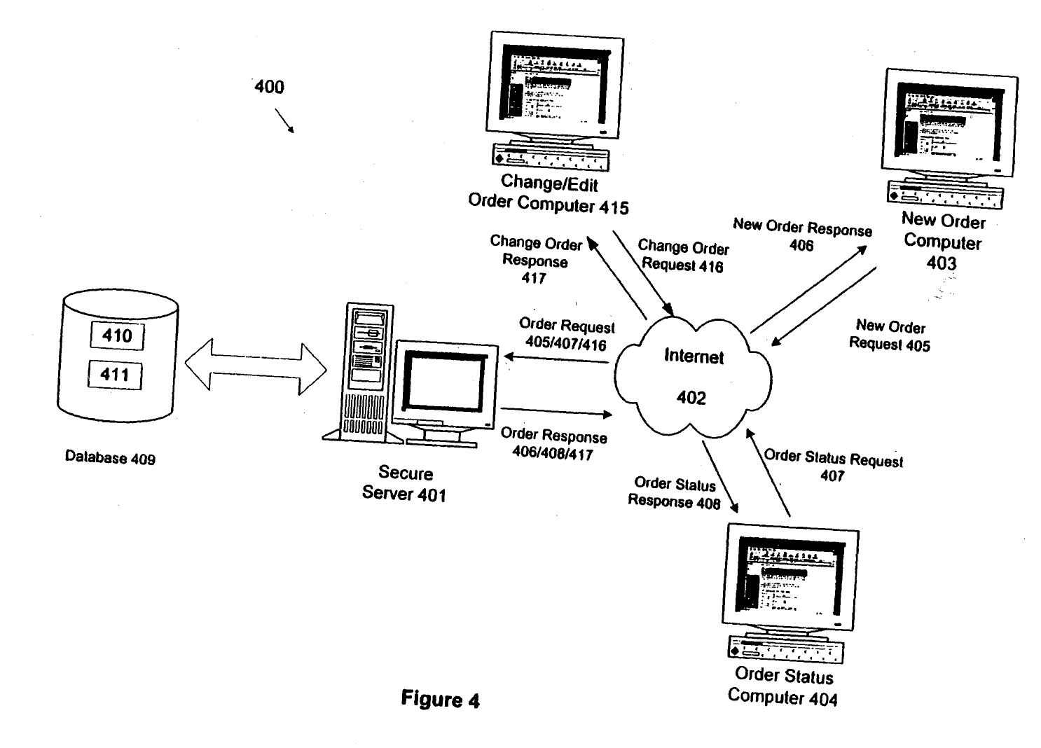

FIG. 4 is a block diagram of an exemplary client/server system 400 in which the transformer ordering system 100 may be implemented. FIG. 4 illustrates an exemplary client/server system 400 for receiving new orders from one or more users (e.g., customers) into the transformer ordering system 100, for editing existing orders, and also for receiving status queries from a user for previously submitted orders.

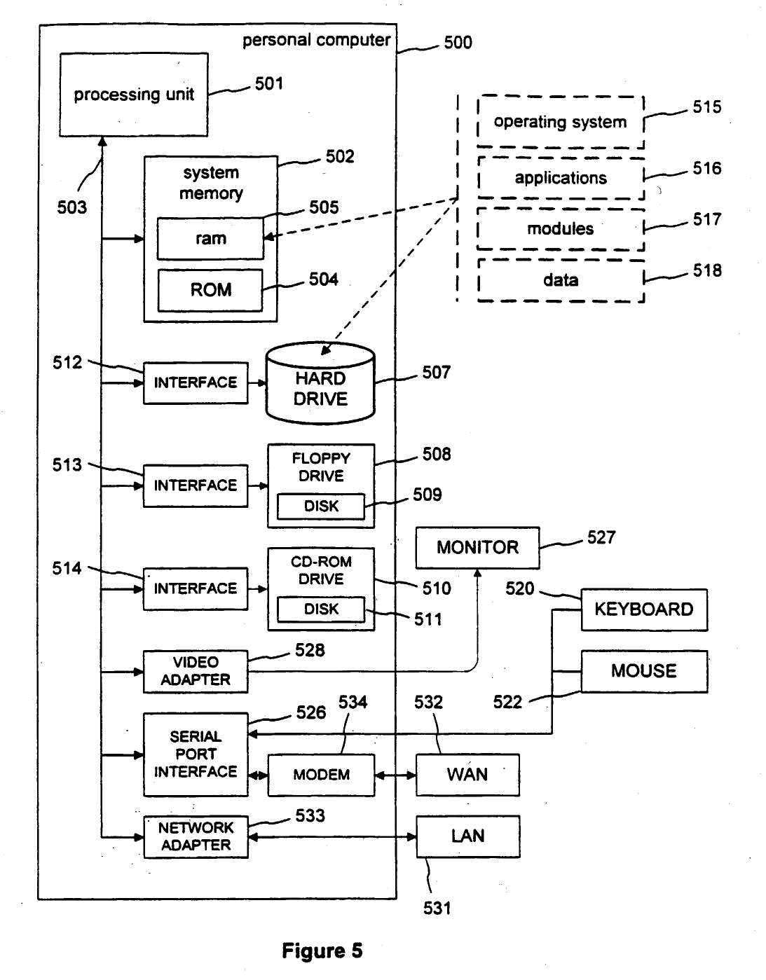

As shown in FIG. 4, the details of a new transformer order and/or order status inquiry may be entered using a network appliance or data entry device. The network appliance may include, for example, computers 403, 404, and 415 of a customer of the transformer ordering system 100, or the like. The structure of computers 403, 404, and 415 is described below with reference to FIG. 5. The transformer ordering system 100 may have a plurality of computers, similar to computers 403, 404, and 415, each coupled to the transformer ordering system 100 through an appropriate interface connection. Each computer 403, 404, 415 may be a dedicated terminal or a multi-purpose terminal with access to network 402, such as an Internet, an Intranet, an Extranet, etc. For example, each computer 403, 404, 415 may be a computer with Internet access located in a customer's office, a customer's home, or a customer's facilities and may be used routinely to access the Internet and to keep and communicate ordering and design data and information between the customer and the transformer ordering system 100. In this instance, new order data 410 and/or order status data 411 may be received and stored by the transformer ordering system 100 after it is received from, for example, a customer who has been granted access to the transformer ordering system 100 (e.g., either for an initial or new order or for ascertaining the status of an existing or previously submitted order).

Alternatively, computers 403, 404, 415 may be a network appliance located at any third party location for access by any individual user, including a customer of the transformer ordering system 100. In this way, a user may request new ordering data 410 and/or obtain the status of an existing order 411 in any environment. Computers 403, 404, 415 may be personal computing devices (as shown in FIG. 5) that have Internet hypertext mark up language (html)-based browser software installed thereon, such as, for example, INTERNET EXPLORER available from MICROSOFT Corporation. It should also be understood that while three computers 403, 404, and 415 are shown in FIG. 4, in practice there may be a plurality of network appliances for submitting new ordering data 410, editing an existing order, and for querying the transformer ordering system 100 to request the status of an existing order data 411.

Although FIG. 4 shows computers 403, 404, and 415 as personal desktop computing devices, it should be appreciated that computers 403, 404, and 415 may be any type of network appliance. For example, each computer 403, 404, 415 may be a wireless personal hand-held device of the type available from PALM Incorporated. Computers 403, 404, and 415 also may be cellular telephone devices or portable laptop computers, both available from a wide array of manufacturers. In fact, computers 403, 404, and 415 may be any kind of processing device able to communicate with a particular network 402, like the Internet.

Preferably, the transformer ordering system 100 includes business to business, as well as business to consumer, enabling technology having an open standards framework and provides gateways to various methods of inter-process communications. The transformer ordering system 100 can be accessed and activated by a person, such as a customer of the system. Alternatively, the transformer ordering system 100 may be accessed by another system. The enabling technology of the present invention preferably includes a server and the framework to allow the system to bring open standards business to business integration. An open standard system is preferred because it allows the system to be readably integrated with most conventional ordering systems, design systems, marketing systems, manufacturing systems, financial systems, communications (e.g., email) systems, and the like. Any suitable enabling technologies can be used with the present invention to allow the transformer ordering system 100 to bring open standards business to business integration. In one embodiment, SYMIX may be used as the business system to provide e-business software and services.

Preferably the enabling technology has two main components, a business to business e-commerce framework built on open standards, and a product that implements the framework on an operating system, such as Windows or the like, and facilitates application integration.

Preferably, the transformer ordering system framework allows business to business e-commerce to be implemented by passing messages among parties (e.g., manufacturers, customers, vendors, designers, shippers, etc.) in a loosely coupled network, such as an Intranet and the Internet This is a time-tested architecture for scalable and reliable transaction processing. All such efforts preferably define message formats that describe the business to be transacted.

As shown in FIG. 4, computers 403, 404, and 415 may be coupled to a secure server 401 via Internet 402. Internet 402 provides the communications network that allows computers 403, 404, and 415 to communicate with secure server 401. Accordingly, computers 403, 404, and 415 may use Point-to-Point Protocol (PPP) methods to communicate with Internet 402. Moreover, client/server system 400 may support the use of a variety of

Internet protocols for data transmission. The primary protocol of Internet 402 may be a hyper-text transfer protocol (http), the protocol but underlies the World Wide Web. Http defines how messages are formatted and transmitted and what action Web servers and browser software should take in response to various commands. Most third-party browser-based software intended for messaging or commerce-based transactions recognize the http protocol. In addition, associated Web pages within client/server system 400 may be formatted and displayed in accordance with html. Html is the language that defines the structure and layout of a Web document using a variety of tags and attributes. In addition, client/server system 400 preferably specifies the use of the Extensible Markup Language (XML). XML allows Web designers to create customized tags thus enabling the definitions, transmission, validation, and interpretation of data among applications. Using such conventional inter-products communications techniques allows client/server system 400 to ensure that transformer ordering system 100 is able to communicate with a variety of third-party products.

Although FIG. 4 shows Internet 402 interconnecting computers 403, 404, and 415 with secure server 401, it should be appreciated that computers 403, 404, and 415 could be implemented with Internet 402 replaced with an alternate communications network, for example, a local area network (LAN) or a wide area network (WAN). Also, the communications network coupling quality credentials secure server 401 and computers 403, 404, and 415 may be a Public Service Telephone Network (PSTN), used in traditional telephone networks.

As shown in FIG. 4, secure server 401 may be coupled to a database 409. Database 409 may include one or more individual databases or, alternatively, may include distinct components of a single database device, such as a central database having a plurality of database partitions. Secure server 401 may be a typical computer device (as shown in FIG. 5) or a dedicated database server device. Secure server 401 may have commercially available database server software installed thereon, for example, SQL SERVER 7.0, available from MICROSOFT Corporation. Secure server 401 allows data to be sent to and retrieved from database 409. These data entries and queries may be made in response to instructions from computers 403, 404, and 415.

The database, or databases, 409 synthesize multiple pieces of new order data 410, edit order data, and order status information 411 that manufacturers and customers of transformers can use in selecting quality distribution transformers that meet the specific needs of the customer. Preferably, the one or more databases 409 allow customers of the transformer ordering system 100 to submit new order submissions 405, changes to existing orders 416, and queries regarding the status of existing orders 407 to the server 401 which can access the database 409 for the requested data and information indicative of a particular transformer specification and/or order status. Using unique ordering and design methodologies and price-adjustments, the transformer ordering system 100 represents state-of-the-art transformer design selection and ordering criteria.

Order information 405, edit information 416, and status inquiries 407 into the secure servers 401 and the database 409 can be of varying levels detail, including, for example, standard queries and custom queries. The databases 409 can also provide storage services for customer-specific design and ordering data. This feature can allow customers to share design and ordering data with the public, vendors, or other customers through the secure server 401 and database 409. This provides for unprecedented access to ordering and design data and information at the customer-specific level. Storage service for customer-ordering and design data may be provided. Preferably, access to the database 409 may be controlled by a system administrator and can be limited to authorized or registered personnel only, or alternatively, different levels of access can be available based on privileges assigned by the system administrator, for example.

Preferably, the secure server 401 includes a four-tier architecture, wherein all applications are designed with reference to an architectural model that separates the client browser, the web server, the business layer, and the database processing into layers. In this instance, computers 403, 404, and 415 may contain the programming that provides the first-tier graphical user interface (GUI) and application-specific data entry forms/reports or interactive data entry. The second-tier business logic may be located within secure server 401. The business logic acts as the server for client requests from computers 403, 404, and 415. As such, it determines what data 410 and information 411 is needed and where it is located. The third tier may include database 409 and any programming that manages read and write access to it. Because the programming for one particular tier can be changed or relocated without affecting the other tiers, the three-tier model makes it easier to continually evolve an application as new needs and opportunities arise.

To ensure scalability, the secure server 401 is preferably a stateless Web server, wherein all parts of the application running on the Web server are stateless so that standard Web server scaling technologies can be applied efficiently. A stateless Web server is appropriate for Internet-based systems because the Internet is intrinsically stateless, as each request for a new Web page is processed without any knowledge of previously requested pages. Also, secure server 401 may have an application session state to manage the Web server's application state. Application session states can be stored in a database 409 or a highly robust and scalable server component built specifically for the purpose of managing the Web application state.

It should also be appreciated that secure server 401 may serve requests using various types of protocol, depending on the type of protocol used by computers 403, 404, and 415. Moreover, although one quality credentials secure server 401 is shown in FIG. 4, it should be appreciated that there may be many individual database server devices acting in unison to respond to the plurality of received data entries and information requests. In this instance, secure server 401 may be replicated and synchronized so that changes made to one database are reflected in all others. Replication enables many users to work with their own local copy of the database but have the database updated as if they are working on a single, centralized database. For database applications where users are geographically widely distributed, replication is often the most efficient method of database access.

In the context of transformer ordering and designing, as will be further discussed, the data and information 405, 407, 416 sent to as well as the data and information 406, 408, 417 retrieved from database 409 may include data and information indicative of transformer design specifications and operating requirements. The data entries to and information requests from database 409 may be initiated by computers 403, 404, and 415.

Due to sensitive nature of the proprietary and pricing data in the database 409, secure server 401 preferably has certain security features. For example, secure server 401 may support any number of security protocols, including Secure Socket Layer (SSL). These security protocols encrypt and decrypt communications with secure server 401 to protect against third-party tampering and unwanted access.

In addition, because of the need to ensure that the proper data and information are returned to the appropriate customer (e.g., person or system) who ordered or requested it, secure server 401 may identify the source of the data. For example, secure server 401 may be capable of detecting an Internet Protocol (IP) address of computers 403, 404, and 415. In this way, secure server 401 may ensure that the data and/or information is sent to the customer who originated the order/request.

Computers 403, 404, and 415 may use a browser or other “front-end” software to communicate with secure server 401 via Internet 402. The nature of the data received by and data and/or information transmitted by the secure server 401 will vary depending on the nature of the user of the network appliance.

As shown in FIG. 4, customer order computer 403 may serve a purpose different than that of order status computer 404 or order edit computer 415. While computer 404 send a requests 407 for previously submitted ordering data and information 411, customer order computer 403 provides a mechanism for the submission 405 of ordering data and information 410 to server 401. As a result, the flow of data and information between order computer 403 and the server 401 differs from order status computer 404. In particular, the server 401 allows the new order computer 403 to send a submission 405 of new order-based data 405, via Internet 402, to the secure server 401 where the new order-based quality data 405 is received and processed by server 401. The new order-based quality data 410 may then be stored by server 401 in database 409. The server 401 may also communicate a response 406, via the Internet 402, to the submitting or new order computer 403. The response 406 can include, for example, a verification that the new order-based data 410 has been received and/or other information or notes relating to the order. By designating certain addressing information in the initial submission or request 405, the appropriate computer is ensured of receiving the correct response 406. Such designation may include, for example, an IP address or an e-mail address.

Although one new order computer 403 is shown in FIG. 4, it should be appreciated that in practice a plurality of computers may be available to submit new order-based data 410. In fact, using Internet 402, or other similar distributed communications network(s), there may be as many computers as there are customers. In this case, each customer, once registered may be given a user name and corresponding password so that a submission 405 or request 407 may be conducted from any computing device. It should be appreciated that the computers 403, 404, and 415 also may be located in any location. For example, one or more computers may be centrally located with other computers, or each computer 403, 404, and 415 may be located at the home or place of business of the customer, or the like. Furthermore, each computer may be a portable device, like a laptop computer or personal digital assistant.

As shown in FIG. 4, order status computer 404 may send a status request 407, via Internet 402, to secure server 401. Also, the secure server 401 may communicate a response 408, via Internet 402, for the requested order status data and information to the requesting computer 404, depending on which one the request for order status data/information originated. Secure server 401 may store the order status request 407 and order status response 408 in database 409.

Upon receiving the order status response 408, containing, for example, previously order-based quality data 411, the user of the order status computer 404 can obtain status informed regarding a previous order.

New order-based data 410 may be entered to or existing order status information 411 communicated from secure server 401 using any number of methods. For example, order status computer 404 may enter order status request 407 using an html browser-based document. Using such a document, order status computer 404 presents the user with a GUI that facilitates the entry of the data related to the desired order using freely entered alphanumeric text, pull-down menu options, and/or predefined selection buttons (not shown). Alternatively, where order status computer 404 is a wireless handheld device, a user may enter existing order status request 407 using a wireless application, as understood by those skilled in the art.

Change/edit order computer 415 sends a change order request 416 through Internet 402 to server 401. The existing order information is accessed from database 409 and the change is stored back into the database. Preferably, the server 401 sends a change order response 417 back to computer 415 for the user.

In any case, the various requests 405, 407, 416 and the various responses 406, 408, 417 may contain various combinations of inputted characters and predefined selection options. It should also be appreciated that order requests and order responses may also include non-alphanumeric graphic based entities, including but not limited to bit-mapped graphic images.

Preferably, the transformer ordering system 100 is enabled via the Internet and secure server 401 is coupled to Internet 402 through one or more interface connections to receive the order-based data and also to provide access to the order-based information previously entered and stored in database 409

Although FIG. 4 shows the invention in the context of the Internet, it should be appreciated that the invention may also be used in the context of an Intranet. Specifically, all elements shown in FIG. 4 may be a part of a singly-owned network of computers and database components that span one facility or a network of facilities, common in the customer context. In this way, a single customer, or a coalition of vendors, may create their own database of transformer ordering data and information from sources exclusively within their own facilities. This would be especially relevant where the Intranet was owned by a power equipment company, responsible for designing and manufacturing a variety of transformers on a daily basis.

Exemplary Computing Environment

FIG. 5 is a block diagram providing a brief description of a suitable computing device. This computing device may be typical of computers 403, 404, and 415, and/or secure server 401. While the invention will be described in the general context of computer-executable instructions of a computer program that runs on a personal computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like.

With reference to FIG. 5, computers 403, 404, and 415 and/or secure server 401 may be conventional personal computer 500, including a processing unit 501, a system memory 502, and a system bus 503 that couples various system components including the system memory 502 to processing unit 501. Processing unit 501 may be any of various commercially available processors. Dual microprocessors and other multiprocessor architectures also can be used as processing unit 501.

System bus 503 may be any of several types of bus structure including a memory bus or memory controller, a peripheral bus, and a local bus using any of a variety of conventional bus architectures. System memory 502 can include read only memory (ROM) 504 and random access memory (RAM) 505. A basic input/output system (BIOS), containing the basic routines that help to transfer information between elements within personal computer 500, such as during start-up, can be stored in ROM 504.

Personal computer 500 further includes a hard disk drive 507 and a magnetic disk drive 508 to read from or write to one or more of a removable disk 509, and an optical disk drive 510 to read a CD-ROM disk 511, or to read from or write to other optical media. Hard disk drive 507, magnetic disk drive 508, and optical disk drive 510 can be connected to system bus 503 by a hard disk drive interface 512, a magnetic disk drive interface 513, and an optical drive interface 514, respectively. The drives and their associated computer-readable media provide nonvolatile storage of data, data structures, computer-executable instructions, etc. for personal computer 500. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the operating environment.

A number of program modules may be stored in the drives and RAM 505, including an operating system 515, one or more application programs 516, other program modules 517, and program data 518.

A user may enter commands and information into personal computer 500 through one or more input devices, such as a keyboard 520 and a mouse 522. Other input devices (not shown) may include a microphone, joystick, game pad, satellite dish, scanner, or the like. These and other input devices are often connected to processing unit 501 through a serial port interface 526 that is coupled to system bus 503, but may be connected by other interfaces, such as a parallel port, game port or a universal serial bus (USB). A monitor 527 or other type of display device is also connected to system bus 503 via an interface, such as a video adapter 528. In addition to monitor 527, personal computers typically include other peripheral output devices (not shown), such as speakers and printers.

Personal computer 500 may operate in a networked environment using logical connections including a local area network (LAN) 531 and a wide area network (WAN) 532. Such networking environments are commonplace in offices, enterprise-wide computer networks, Intranet and the Internet. When used in a LAN networking environment, personal computer 500 is connected to LAN 531 through a network interface or adapter 533. When used in a WAN networking environment, personal computer 500 typically includes a modem 534 or other means for establishing communications over wide area network 532, such as the Internet. Modem 534 is connected to system bus 503 via serial port interface 526. It will be appreciated that the network connections shown are one example, and that other means of establishing a communications link between the computers may be used.

In accordance with the practices of persons skilled in the art of computer programming, the present invention is described below with reference to acts and symbolic representations of operations that are performed by the personal computer 500, unless indicated otherwise. Such acts and operations are sometimes referred to as being computer-executed. It will be appreciated that the acts and symbolically represented operations include the manipulation by the processing unit 501 of electrical signals representing data bits which causes a resulting transformation or reduction of the electrical signal representation, and the maintenance of data bits at memory locations in the memory system (including the system memory 502, hard drive 507, floppy disks 509, and CD-ROM 511) to thereby reconfigure or otherwise alter the computer system's operation, as well as other processing of signals. The memory locations where data bits are maintained are physical locations that have particular electrical, magnetic, or optical properties corresponding to the data bits.

The following is a general description of the operation of an exemplary network based system 100 for the on-line design of distribution transformers.

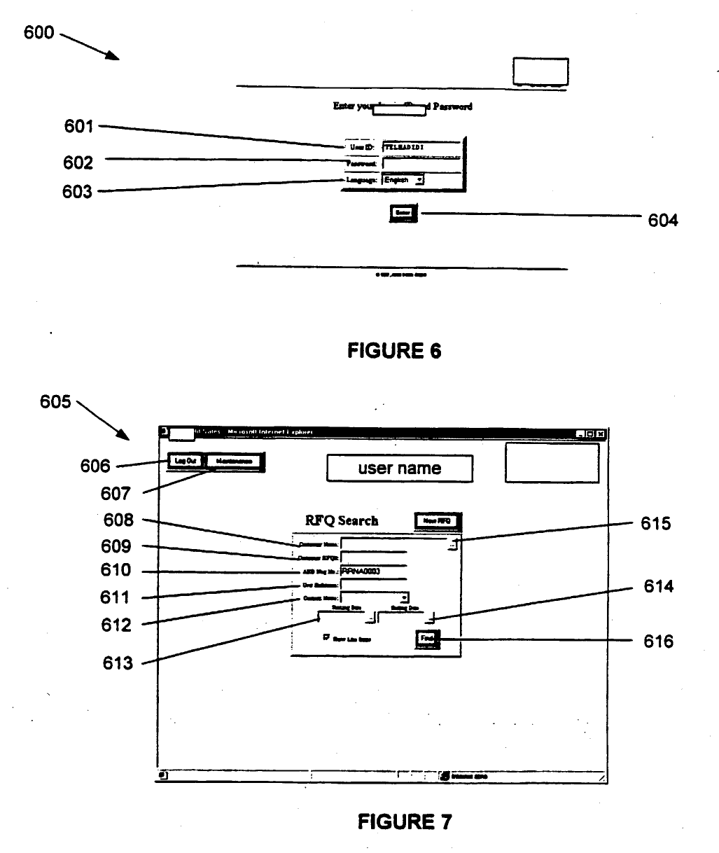

FIG. 6 shows an exemplary Login Screen 600. As shown in FIG. 6, to begin using the system software (not shown), a user (e.g., a customer) logs into the on-line system 100 by entering an User ID in the User ID field 601 provided. The user can tab to the Password field 602 and enter his or her password. The password is preferably set when the User ID is assigned. For security reasons when a user enters his or her password in the text box, the entry is not displayed on the screen. Passwords can consist of any combination of keyboard characters. The first character of the password is preferably an alphanumeric character. If a user needs to change his or her password, then he or she can use the maintenance button to perform this function.

If the user wishes to operate the system using the English language function, then he or she leaves the language selection set to English in language selection field 603, which is preferably the default setting. Preferably the on-line design system 100 includes a language dictionary that has been fully populated with the necessary terms. The user can click on the Enter button 604 to move to the next screen.

FIG. 7 shows the next screen, which is the RFQ (Request For Quote) Search Screen 605. As shown in FIG. 7, the RFQ Search screen 605 allows the user to search for an RFQ that has already been entered into the transformer ordering system 100 or allows the user to initiate a new RFQ. The following section describes an exemplary process for searching for existing RFQ's. An exemplary process for creating new RFQ's is described after the section describing how to search for existing RFQ's.

Additional buttons 606, 607 at the top of the RFQ search screen 605 allow the user additional functionality. For example, the Log Out button 606 takes the user back to the first Log In screen 600. The Maintenance button 607, available to those with system maintenance privileges, takes the user to the system maintenance functions described in detail below.

A user can search for an RFQ by entering information in one or more of the Customer Name field 608, Customer RFQ Number Field 609, Manufacturer Number field 610, User Reference field 611, Contact Name field 612, and/or Date field 613. When using any of these fields other than the date fields, the usr may enter either a complete value or use a wild card character. The date fields 613 will not accept the wild card characters. Preferably, the system is setup such that the manufacturer number field 610 and the date field 613 are automatically filled in, so the usefulness of searching the rest of the fields will depend on the rigor that the users apply in completing them.

The * is used for wild card searches. For example, if a user decides to search for an RFQ using the manufacturer number and only remember the first few numeric values, a user might enter RATH028* to find all RFQs beginning with “RATH028.”

The search can also be narrowed by date by entering a Starting and Ending Date. Dates are preferably entered in the DD/MM/YYYY format or by using a calendar function, which is preferably available by clicking on the three dots on the buttons 614 to the right of these fields, as shown in FIG. 7.

The user may change the Month or Year using a popup or drop-down box (not shown) by making a selection. To move the date forward from the currently highlighted date, the user may enter the number of, for example, weeks in the box to the right of the date and toggle up to change the date. The calendar will preferably move to the appropriate month and day that corresponds to the number of weeks that the user has entered. The user may also click on a day for the currently displayed month. Once the user has selected the correct date, he or she may click on the Close button (not shown) to close the date drop-down box. The date will be entered into the date field 613 from which the user accessed the calendar.

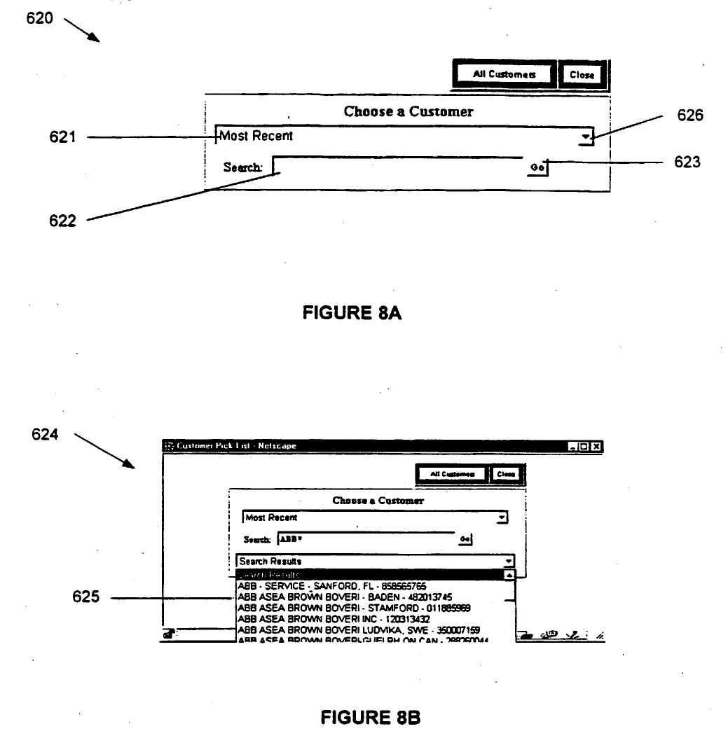

The user may also search by customer. If the user clicks on the three dots on the button 615 to the right of the Customer name field 608, the Choose Customer screen 620 is displayed, as shown in FIG. 8A.

The user may click on the list box button for the top field 621 and select a desired customer if they are one of most recent with whom the user has been working on an RFQ. If the customer is not in this list, the user may enter a name or part of a name followed by the wild card character (*) into the Search field 622 and click on the Go button 623.

After a few seconds, the Search Results screen 624 is displayed, as shown in FIG. 8B. The user may use the list box indicator and the scroll bar at the right of the list to scroll through and select the customer that the user is seeking.

The user may then click on the desired customer and the system returns to the RFQ Search screen 605 with the customer filled in the appropriate field. If the user needs to load a new customer, he or she may use the maintenance button 607.

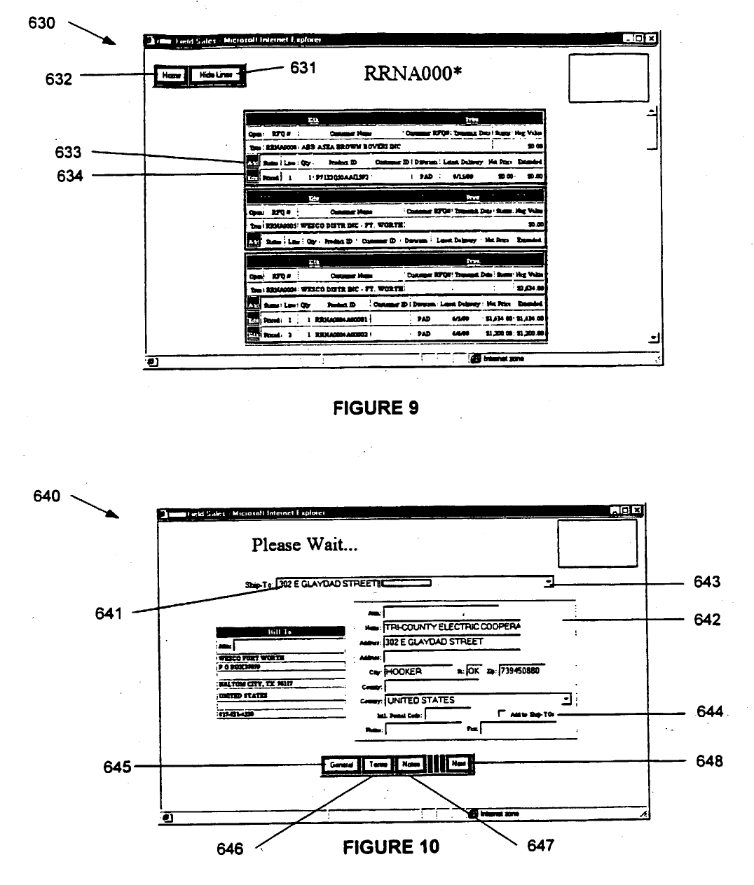

Once the user has entered his or her search criteria, then he or she may click on the Find button 616. The RFQ Results screen 630 is displayed, as shown in FIG. 9, with one or more RFQs that match the user's request. If none match the search criteria, a screen (not shown) will be displayed which informs the user of this.

If the user prefers to see only the RFQs without details (items), he or she may click on the Hide Lines button 631, shown in FIG. 9. If the details (items) are being hidden from the user, the caption on the Hide Lines button 631 becomes “Show Lines.” Clicking on the Show Lines button 631 will redisplay the details (items). The user may also return to the Search Screen 605 by clicking on the Home button 632. The user may recall details on any of the RFQ's shown in this summary by clicking an appropriate buttons on each of the negotiations. The user may continue adding items to an RFQ at this time by clicking on the Add button 633. Details of the function of the Add button are discussed in more detail under the Shopping Cart section. An RFQ may be edited by clicking on the edit button 634.

The following section discusses an exemplary process for creating a new RFQ. Referring back to FIG. 7, to create a new RFQ, the user clicks on the New RFQ button 617 on the RFQ Search screen 605.

A Choose a Customer Screen 620 will be displayed, such as that shown in FIG. 8A. As shown in FIG. 8B, the user is prompted to choose a customer from the Choose a Customer screen 620. The user clicks on the drop down box button 626 from the top field and selects a desired customer if the customer is one of the most recent for whom the user has been working on an RFQ.

If the desired customer is not in this list, then the user may enter the customer's name or part of the customer's name followed by an * and click on the Go button 623 next to the Search field 622.

Next, the Choose a Customer screen 624, similar to the screen shown in FIG. 9, is displayed. The user may click on the drop down box and may use the scroll bar at the right of the list to move down through and select the customer he or she is seeking. The user clicks on the desired customer to complete the customer selection.

FIGS. 9 and 10 show an exemplary Ship To screen 640 that is displayed next.

As shown, the RFQ number is displayed at the top of the screen in field 641.

The shipping information box 642 to the right contains the basic customer shipping information. The user can click on the drop-down box 643 next to the Ship To field 641 to select an address that is currently in the database. If the desired address is not in the database, the user can fill in the Ship To screen 640 manually. If the address is added manually, the new address can be saved in the database for later use by checking the Add to Ship To's box 644.

As shown in FIG. 10, there is a series of buttons displayed at the bottom of the screen 640. The General button 645, Terms button 646, Notes button 647, and Next button 648 are displayed.

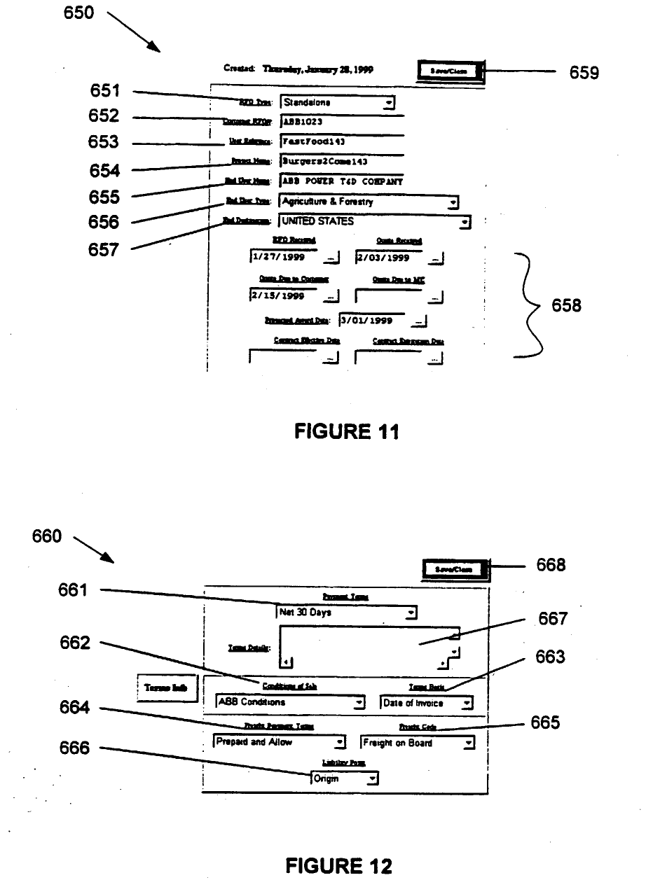

The user may click on the General button 645 of the Ship To screen 640 to bring up the General screen 650 to enter information about this customer's RFQ. FIG. 11 shows an exemplary General Customer Information Screen 650. RFQ types 651 can include, for example, Standalone, Blanket, Estimate, Future Business, Missing Business, RMR, and the like.

Customer RFQ 652 is a customer assigned number for the negotiation and is recorded, if known, for the purpose of further searches. User Reference 653, Project Name 654, and End User Name 655 are free-text fields. The End User Type 656 and drop down box allows the user to assign a type of business to each customer. End Destination 657 refers to the location (e.g., country) where the order will be shipped. The remaining fields include date fields 658 for different activities in the RFQ process. When the user has completed this screen, he or she may click on the Save/Close button 659 and the information is saved to a database. The Ship To screen 640 (FIG. 10) is displayed again.

FIG. 12 shows an exemplary Customer Terms screen 660. As shown in FIG. 12, the Customer Terms screen 660 is used to enter information about terms of the sale. Preferably, the user may use drop down boxes for all fields (e.g., payment terms field 661, condition of sale 662, terms basis 663, freight payment terms 664, freight code 665, and liability point 666) except the Terms Detail box 667 that is provided to type in free-form text. Preferably, the default Payment Terms is Net 30 and the default Freight Code is Freight on Board (FOB). Preferably, the Terms Basis is as early as possible, usually meaning the Date of Invoice.

When the user has completed this screen, he or she may click on the Save/Close button 668 and the information is saved to the database. The Ship To screen 640 is displayed again.

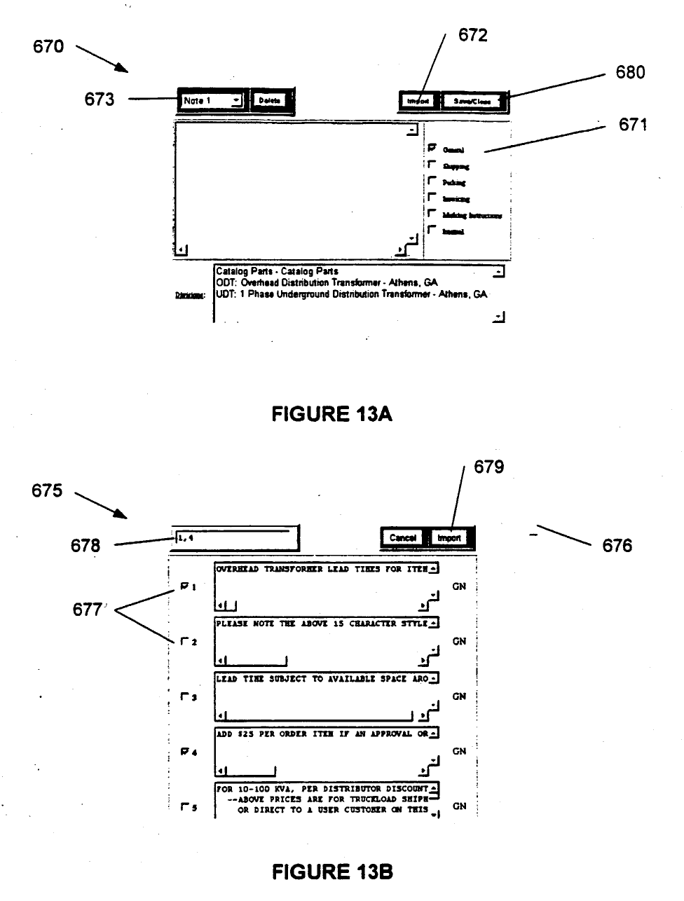

FIG. 13A shows an exemplary Notes Summary Screen 670. As shown in FIG. 13A, the Notes Summary screen 670 is used to attach notes to the RFQ. As shown in the category box 671, these may be categorized into different types related to each of the stages in completing the order, such as, for example: General, Shipping, Packing, Invoicing, Marking Instructions and Internal. Internal notes are preferably not printed on customer correspondence.

The user may click in the appropriate check box of category box 671 to select the type of note he or she wishes to add to the RFQ. Many of the necessary notes could already be stored in the database such that the user simply clicks the Import button 672 to access and import the desired notes. The Imported Notes screen 675 is displayed to the user for the selected category.

FIG. 13B shows an exemplary Imported Notes screen 675 for the General category. As shown in FIG. 13B, the user can use the scroll bar 676 on the right to scroll down to see all notes. The user may select notes by clicking in the check box 677 next to the note or by typing the numbers, separated by commas, in the field 678 at-the upper left.

After completing a selection, the user clicks on the Import button 679. The Notes Summary screen 670 is again displayed with the notes that the user has selected for that category. The user may review the notes by selecting the note numbers in the drop down box 673 in the upper left corner of the screen. The user may add a New Note using the same drop down box.

FIG. 13A shows an exemplary Note Summary Screen. Once the user has completed selecting and reviewing notes for each category, he or she may click on the Save/Close button 680 and the information is saved to the database. The Ship To screen 640 (FIG. 10) is displayed again. The user then clicks on the Next button 648 on the Ship To screen 640. The Shopping Cart screen 685 is displayed.

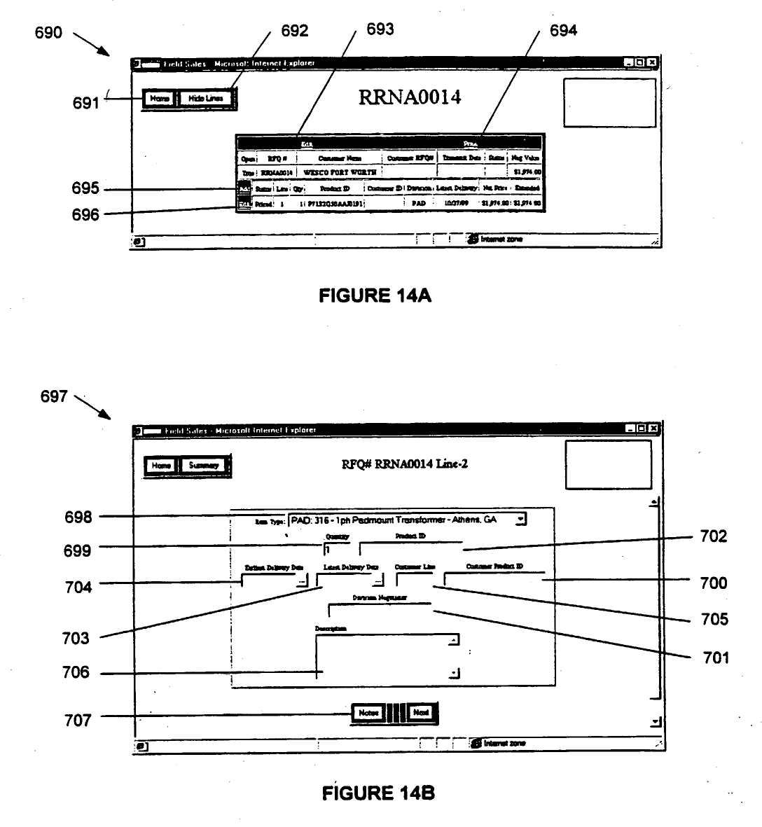

FIG. 14A shows an exemplary Shopping cart screen 690 where the user creates the RFQ by adding items. As shown in FIG. 14A, there is a Home button 691 and a Hide Lines button 692 to the left of the RFQ number.

The Edit button 693 and Print button 694 above the line items operate for the whole RFQ. The Edit button allows the user to change information about the customer and the RFQ in general, such as terms or notes. Print will create a copy of the RFQ and download or print it. To work with line items use the Add button 695 to create and (after creation) the Edit buttons 696 at the left of the line item area of the screen. When the Shopping Cart is first displayed it contains no items.

To add an item, the user clicks on the Add button 695 at the left of the Shopping Cart screen, next to the Status box. The Line Item screen 697 is displayed, as shown in FIG. 14B. Certain fields, such as the Item Type 698, Quantity 699, Latest Delivery Date 703, and Manufacturer Negotiator 701, may be required fields.

FIG. 14B shows an exemplary Line Item Screen 697. In one exemplary embodiment, the user may select “PAD: 316—1ph Pad-mount Transformer—Athens, Ga.” as the Item Type. Next, the user may enter the Quantity for the items. The user may be required to fill in the Latest Delivery Date and the Manufacturer Negotiator name. This is the person at the manufacturer who is responsible for the quotation and is usually the person filling in the RFQ.

The user may optionally enter a product ID in Product ID 702, if it is known. But, the preferred handling of the Product ID field is to leave this field blank and allow the system to assign an appropriate product ID. The Earliest Delivery Date field 704 is also optional. If the user knows this information then he or she may enter the Customer Line 705 and Customer Product ID 700. The Description field 706 is preferably a free text box that may be completed by the system.

The Notes button 707 accesses the same notes information discussed previously in the Ship To section under the Notes. These notes will refer to the specific item. When the user has finished entering information in the Notes, he or she clicks on the Save/Close button on the Notes screen and the Line Item screen 690 is displayed again.

When all information about an item has been completed, it is time to design the item. The user clicks on the Next button # to initiate the design process. The Design Creation is the next important step in completing an RFQ.

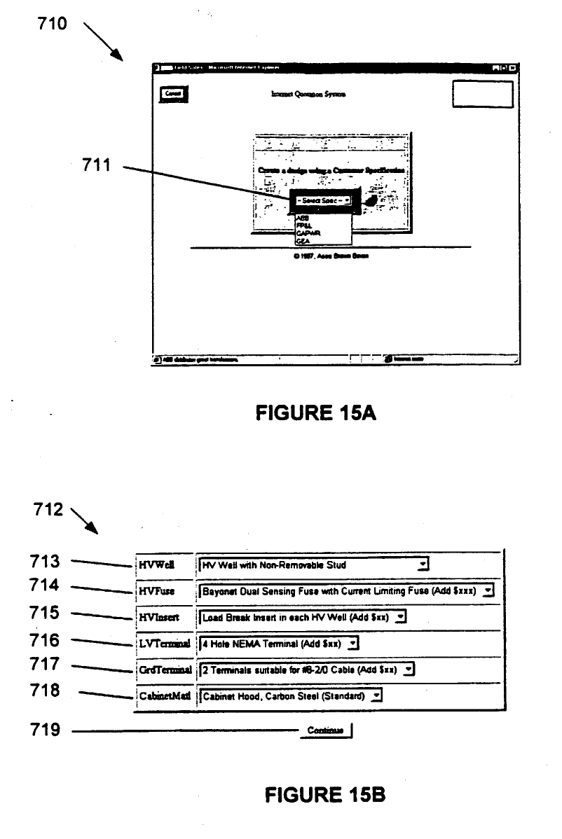

FIGS. 15-20 and the following description show how to create an exemplary Single Phase Pad-mount Transformer design. The first section will detail how to use one manufacturer specification that has been verified and entered into the transformer ordering system. A short section following will quickly describe how other specifications may differ.

The Customer Specification screen 710 is used to select which specification will be used to design the item. FIG. 15A shows an exemplary Design Specification Screen 710. As shown in FIG. 15A, the user my use the drop down box 711 to select one of the options as a specification for design. Various manufacturer design specifications are the standard and others can be added as they become available for specific customers when they have been completely verified and loaded.

The user may select the desired manufacturer specification, such as a transformer specification manufactured by ABB Power T&D Co., Inc. This option will start the Accessories. FIG. 15B shows an exemplary Design Accessories screen 712. As shown in FIG. 15B, the Accessories screen 712 is used to identify which accessories to add to the basic transformer, such as HV Well Bushing option 713, HV Fuse option 714, HV Bushing Insert option 715, LV Terminals option 716, Ground Terminals option 717, Cabinet Material option 718, and the like. The user may use the drop down boxes to select an option if the one shown is not what he or she wants. When the user has completed this screen, he or she may click on the Continue button 719.

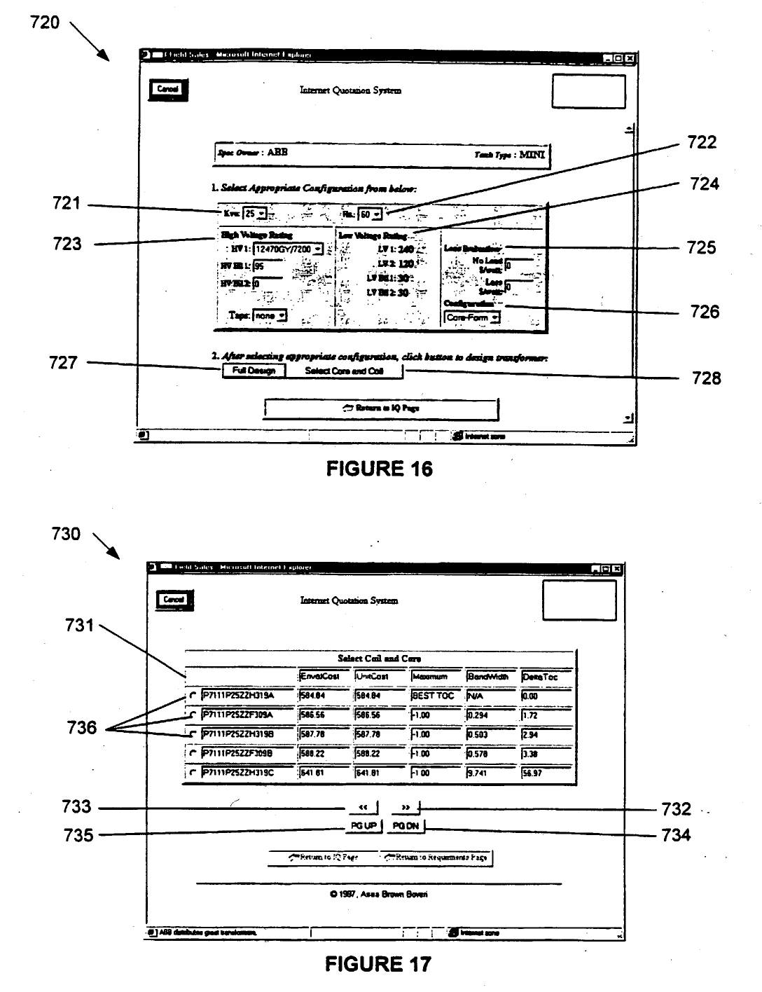

FIG. 16 shows an exemplary Ratings screen 720 which can be used to select the ratings for the transformer that the user wants. The user may use pull down boxes to select the configuration for the item. The Ratings screen may include selections for the appropriate configuration, such as a power field 721, a frequency field 722, a high voltage rating field 723, a low voltage rating field 724, a loss evaluation field 725, and a configuration field 726. Preferably, the high voltage ratings and kVA's shown on this screen will be only those that are approved for the particular customer specification that has been selected.

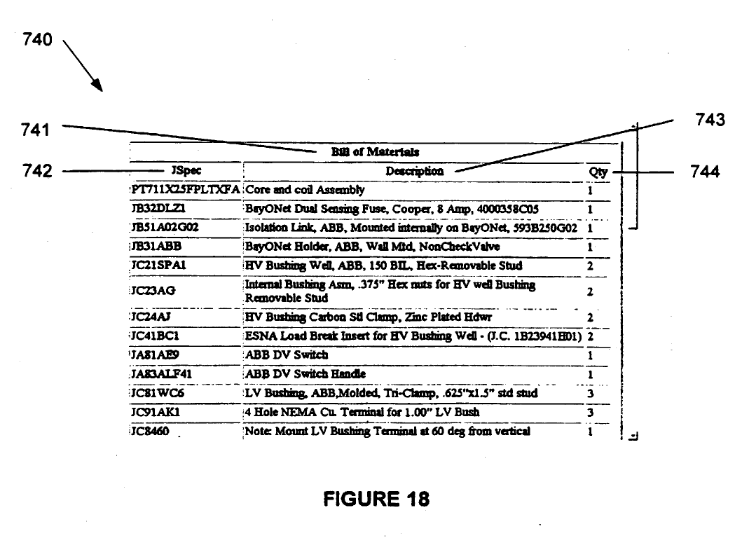

After selecting the appropriate configuration, the user may click on the Full Design button 727 to configure the desired transformer. This process will complete a bill of materials, selecting a core and coil from a sorted list satisfying these specified ratings. The list is sorted by Total Owning Cost (TOC) for candidate core and coil designs using the No Load and Load Loss evaluation fields. Preferably, the process automatically selects the lowest TOC. A dialog box (not shown) will ask the user to wait while the design is completed. After selecting this option, the Bill of Materials screen 735 is displayed, as shown in FIG. 18.

Alternatively, the user may click on the Select Core and Coil button 728 if he or she wants to review the sorted list of core and coil designs. The user then has the opportunity to select the core and coil assembly that he or she wants. The Select Core and Coil screen 730 is displayed.

FIG. 17 shows an exemplary Select Core and Coil screen 730. As shown in FIG. 17, this screen displays a sorted listing of core and coil options in field 731. To see more of the data for each row, the user may click on the >> button 732. To move back to the left, the usr may click on the << button 733. The PG DN and PG IJP buttons 734, 735 enable the user to look at more entries further down in the table and then to move back up, one page at a time.

The user may click on the Radio button 736 next to the item that represents the Core and Coil he or she wants to use. A dialog box (not shown) will ask the user to wait while the design is completed. After selecting this option, the Bill of Materials screen 740 is displayed.

FIG. 18 shows an exemplary Bill of Material screen 740. As shown in FIG. 18, the Bill of Material (BOM) shown in field 741 is for an exemplary manufacturer specification by ABB Power T&D Co., Inc. and includes the Jspec (item) 742, a description 743, and a quantity 744. This information is preferably for internal use only. The user may review the BOM and then click on the button at the bottom of the screen (not shown). The button is labeled View Design if the user is coming from the Select Core and Coil option and is labeled Publish Design if the user is coming from the Full Design option.

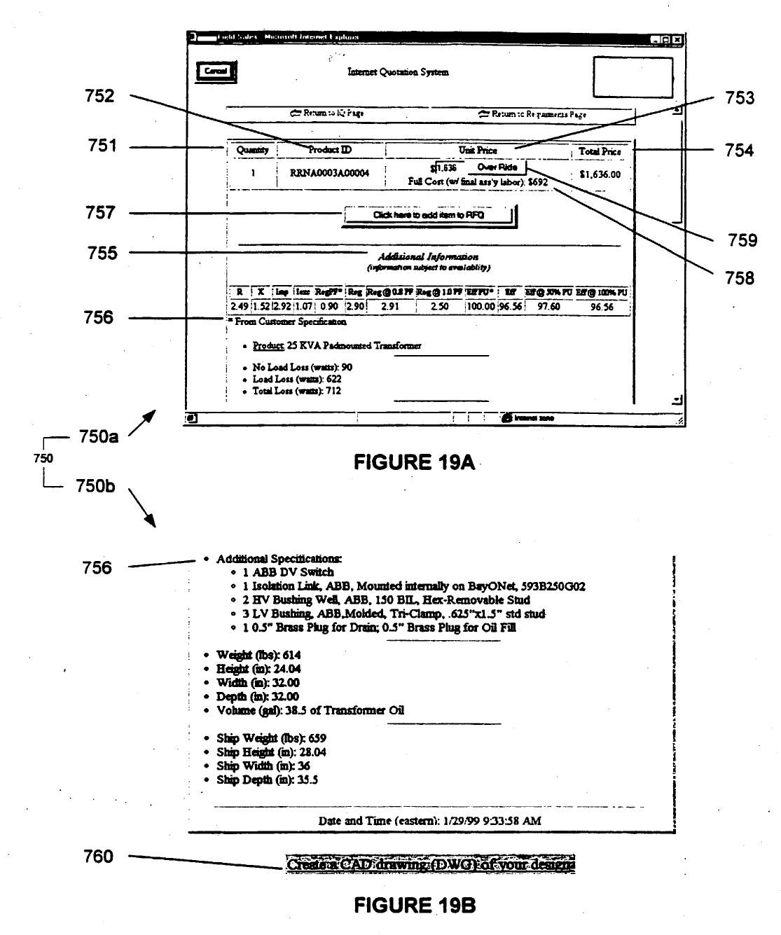

After clicking on the View Design button, the External View of RFQ (or Publish) screen 750 is displayed. FIG. 19A shows the top portion of one such screen 750a This is the format and content of the data that will be added to the full negotiation data once the item is added to the shopping cart. The top portion of the Published Design screen 750a includes the following fields: quantity 751, product ID 752, unit price 753, total price 754, additional information 755, and information from the customer specification 756 (if this information is available). A button 757 is provided to add the item to the RFQ.

Preferably, the Unit Price textbox 753, the Full Cost value 758 and the Over Ride button 759 are visible and available only to those users authorized to see the cost and to modify pricing. For those with this authority, the user may change and store a new unit price. The Over Ride button 759 saves a change to the price entered in the box to the left and changes the value in the Total Price field 754. Pressing the Over Ride button 759 also causes the full cost model to recalculate the full cost. FIG. 19B shows the bottom portion of this item description, including specification field 756. A portion of the Published Design screen 750 with additional specifications between these is not shown.

If the user wants to create outline drawings in, for example, AutoCAD Release 14 format, then he or she may click on the Create a CAD drawing (DWG) of his or her design button 760, as shown in FIG. 19B. This creates the outline drawing on the server and offers the user the opportunity to download the drawing to their local machine. Downloading the file to the user's local machine allows the user to attach and send the file with the RFQ between the manufacturer and the customer. In this embodiment, the file is in AutoCAD “*.dwg” format. Normal AutoCAD viewers, including AutoCAD itself, will be capable of opening and viewing this file.

When the user has finished working with this screen, he or she may click on the Click here to Add item to RFQ button 757 to add this item to the RFQ. The screen will notify the user of this process while returning him or her to the Shopping Cart screen 690 (FIG. 14A) where the user should see the addition of this item. This page may be printed by right clicking the mouse and selecting Print from the resulting menu (not shown).

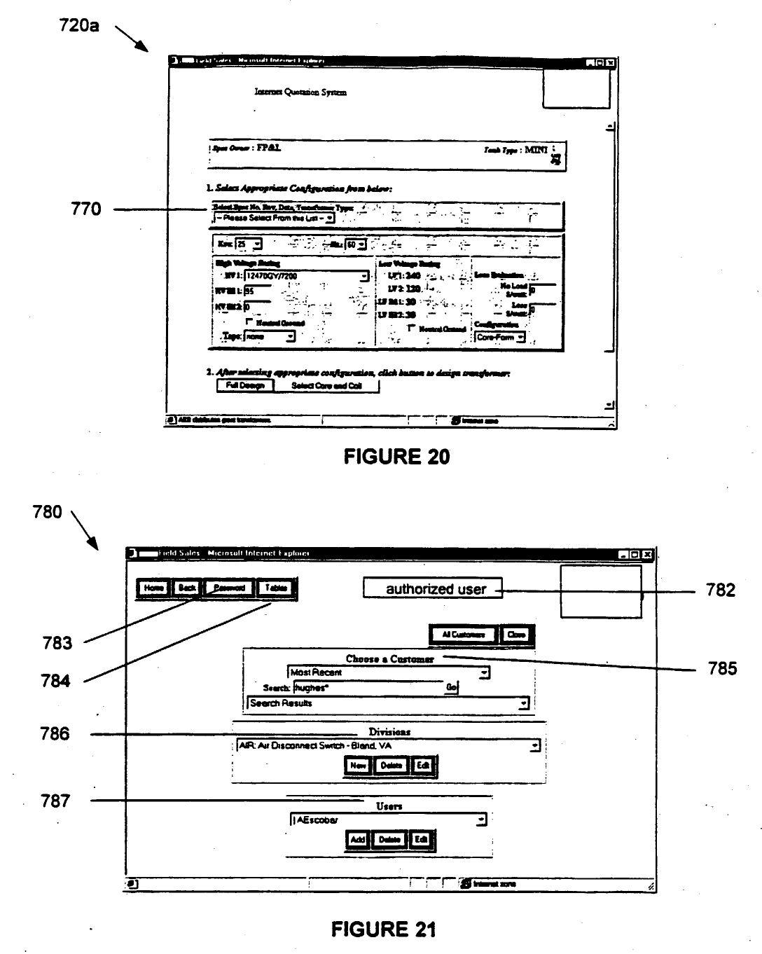

Selecting a specification other than a loaded and verified manufacturer specification (e.g., a non-ABB specification) bypasses the Accessories screen 712 (FIG. 15B) and displays the alternate Specification Ratings screen 720a As shown in FIG. 20, this screen 720a is identical to the Ratings screen 720 for the ABB specifications (FIG. 16) except that it contains an extra drop down box 770 which allows the user to select from the specification, revision, and transformer types defined in the specifications loaded for this customer. The user may click on the drop down box 770 to select the desired specification. From this point the process is the same. The user selects Full Design or selects Core and Coil, reviews the Bill of Materials, publishes the design and adds the item to the shopping cart, pausing first to create outline drawings if he or she so desires.

To Edit a Line item, the user may return to the Shopping Cart screen 690 (FIG. 14A) and clicks on the Edit button 634 next to the item to be edited. The Line Item screen 697 (FIG. 14B) is populated and displayed with all of the data previously entered for this item. Any of the information may be changed. The user edits the desired entry by following the same process as for adding an item and by making sure to remember to click on the Click here to Add item to RFQ button 757 on the Published Design screen 750 to finish the item.

The original (e.g., old) version of the item is removed from the database upon leaving the Shopping Cart screens. The item is completed and returned to the shopping cart in order to properly replace all of the data.

FIG. 21 shows an exemplary Maintenance screen 780. As shown in FIG. 21, the Maintenance screen 780 is displayed when the user presses the maintenance button 607 on the RFQ search screen 605 (see FIG. 7) at the beginning of the process. This screen enables the user with sufficient permission levels to accomplish certain types of system maintenance. For example, these functions may include adding or editing customer data, adding or editing Manufactures, adding or editing users, etc.

The Customer data can be located using the same search process that was discussed in the section on Searching for an RFQ. Care should be used in adding new customers to assure that the data is correct, particularly the DUNS number. The DUNS number is used as an index to several tables. Once entered, the DUNS number is the one field that preferably can not be edited. As shown in FIG. 21, the Maintenance screen 780 includes an authorized user field 782, a password button 783, a tables button 784, a choose a customer field 785, a manufacturer or divisions field 786, and a users field 787.

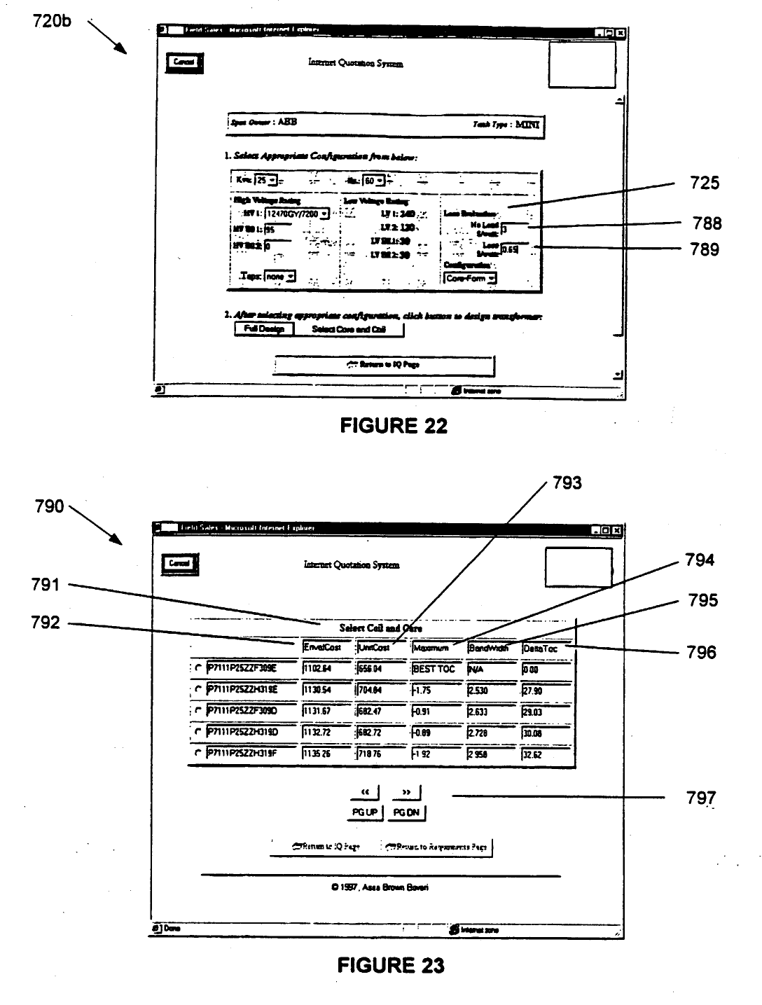

FIG. 22 shows an exemplary Rating screen 720b, which is similar to the Ratings screen 720 of FIG. 16, with the Loss Evaluation field 725 filled-in. The loss evaluation criteria are used to sort multiple designs by the sum of the first cost plus the cost of the losses evaluated over the life of the transformer. The formula looks like:

TOC=First Cost+(NLEvaluation*NL Losses)+(LLEvaluation*Load Losses)

The NL evaluation value, in Dollars per Watt, is retrieved directly from the screen. The LL evaluation value is also retrieved directly from the screen. As shown in FIG. 22, input values of $3.00 for the NL field 788 and $0.65 for the LL field 789 are illustrated The losses are retrieved from the database for each of the Core/Coil designs being evaluated. Specifically, for the embodiment shown, the system retrieves the no load loss and load loss values for the single voltage designs. The calculations are performed and the data is displayed on the selection form, as shown in FIG. 23.

The “First Cost” term in the above equation is simply the cost of the transformer. This may be the full selling price of the transformer if the user is trying to mimic the ultimate customer or it may be some fraction of the selling price. For the Core/Coil Selection screen 790, FIG. 23, the First Cost term is only a portion of the total selling price. As shown the Core/Coil Selection screen 790 includes a Total Evaluated Cost (TOC) filed 792, a Unit Cost field 793, a Maximum field 794, a BandWidth field 795, and a DeltaToc field 796. Toggle buttons 797 are also provided for moving left and right, and up and down in the Core/Coil Selection screen 790. In the embodiment shown, an assumption has been made that the values not included in this term on this screen are constants for all of the designs being evaluated. This of course is only an approximation, but is generally acceptable for this purpose.

The “First Cost” term that shows the select coil and core field 791 on the Core/Coil Selection screen 790 is “UnitCost” field 793 which is actually the sum of the 9 cost fields in the LWCT database. These terms may include:

HVCOST: The HV conductor cost. This field should be quite accurate

LVCOST: The LV conductor cost. This field should be quite accurate.

INSDTCST The cost of the insulation and duct materials. In LWCT, this is an approximation. The LWCT program does not track the ordering details or the cost of all of the insulation parts and pieces. The value is small compared to the other cost numbers, so the approximation is probably acceptable.

CLABRCST: The coil labor cost. This value is still under evaluation for both the core-form lines and TXF. The costing rate, retrieved directly from Symix, for the TXF line is also an approximation, but it will match the Symix costing rate at the time of the design.

CORECOST: This core cost should also be accurate.

OILCOST: The oil volume is calculated in LWCT as the raw tank volume minus the displacement of the HV conductor, LV conductor, and insulation. It should be close to a real value, although the design program will recalculate it once the actual tank has been designed or selected, and the displacement of all of the components have been taken into account.

TANKCOST: This is an approximation. The optimization process has a tank table which provides a tank cost value. This cost value must represent all tanks of that size, regardless of the accessories. Of course, any accessory cost not represented here should be constant for all of the designs being considered and should not affect the sorting of the displayed c/c designs.

MISLABOR: This includes any cost for miscellaneous labor.

MISCMATL: This includes any cost for miscellaneous materials.

As shown in FIG. 23, the “unit cost” data shown on the Core/Coil selection screen 790 is the data from the LWCT program. This data is used to sort the available core/coil designs It is not generally considered to be the actual cost of the unit Just as the EVAL costs in the system are only approximations, and, for EVAL, don't even include estimates for the tank and oil costs, here these core/coil costs are only approximations of the total bill of material. They are shown only to allow the user to make tradeoffs between the approximated first cost and the evaluated losses.

Occasionally, radically different designs result in similar TOC values but vary dramatically in first cost. On those occasions, the user may want to choose the design that results in the lower first cost. For the TXF process, at least for this embodiment, the few core/coil designs should be carefully chosen. Any radical swings in first cost and TOC can therefore be eliminated. The value of using this core/coil selection screen has been significantly reduced, and could be eliminated entirely if the user was not interested in playing with the small differences that might occur between the few choices.

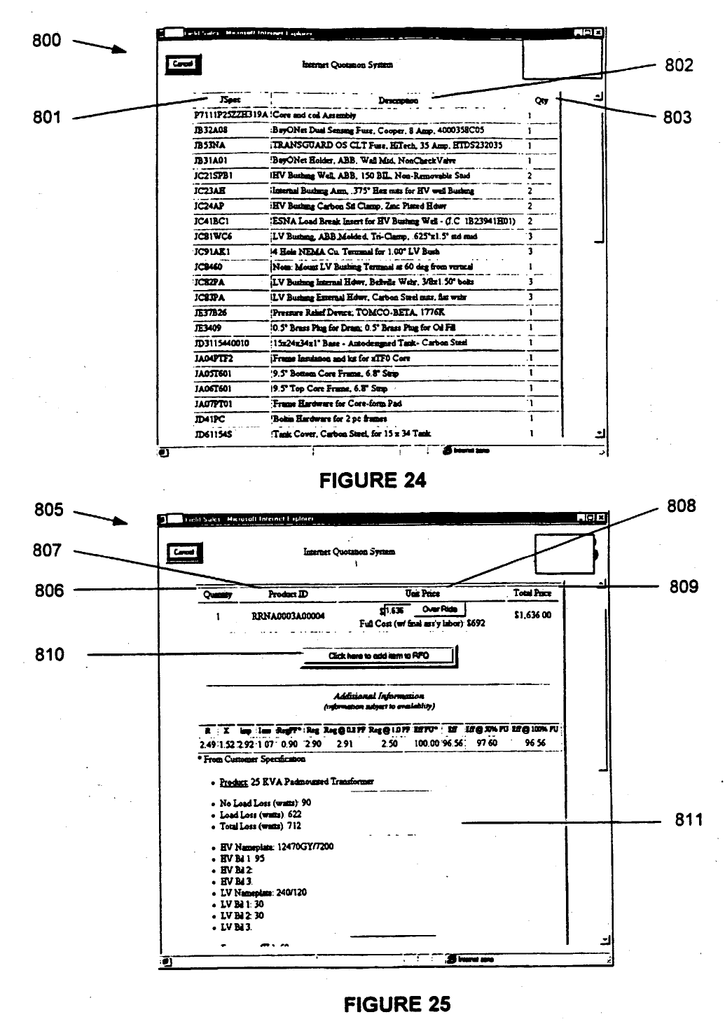

Once the Core/Coil selection is complete, the bill of material can be accumulated and displayed. FIG. 24 shows an exemplary Bill of Material screen 800 (as shown, cost data is a hidden column). The cost data for each “J-spec” (item) 801 is also accumulated along with the bill of material that is displayed on the Bill of Material screen 800. A description field 802 and quantity field 803 are also provided. Note that here the costs are only the cost for each of the individual items, or J-specs (item). These J-spec costs accumulate the material, labor and overhead costs of each of the parts listed under each of the J-specs (item). In this example, this summation process results in:

| Matlcost | Labor | Ovhd | Total |
|---|---|---|---|
| 431.66 | 23.54 | 31.84 | 487.04 |

This bill of material screen for the above embodiment does not accumulate any of the assembly labor to put the J-specs (item) together. Nor does the user get the opportunity to see the details of this labor analysis, but the full cost model does include the following assembly labor costs for the finished transformer.

| | | Labor rate | |
|---|---|---|---|
| Workcenter | Run Time | $/hour | Labor Cost |
| 253-10 | 0.0054 | 24.82 | 0.134028005 |
| 256-20 | 0.15 | 24.82 | 3.723 |
| 256-30 | 1.09 | 24.82 | 27.0538 |
| 256-40 | 0.98 | 24.82 | 24.3236 |
| 256-50 | 0.17 | 24.82 | 4.2194 |
| 256-60 | 0.25 | 24.82 | 6.205 |
| | | Sum | 65.65882801 |

Thus, for this example, the bill of material cost would accumulate to $487. The final assembly labor would add another $66, for a total of $553. The full cost calculations would then inflate this value further to $692 after adding in the G&A costs, the shipping costs, depreciation and other expenses. FIG. 25 shows an exemplary Pricing screen 805 for the above example. As shown, the Pricing screen 805 includes the quantity 806, the Product ID 807. The Unit Price 808, the Total Price 809, a button 810 to add the RFQ to the shopping cart, as well as a field 811 for additional information about the RFQ.

It is to be understood, however, that even in numerous characteristics and advantages of the present invention have been set forth in the foregoing description, together with details of the structure and function of the invention, the disclosure is illustrative only, and changes may be made to detail, especially in matters of shape, size and arrangement of parts within the principles of the invention to the full extent indicated by the broad general meaning of the terms in which the appended claims are expressed.

What is claimed is:

1. A system for facilitating the on-line configuration and pricing of a distribution transformer, between one or more users and one or more manufacturers of transformers, over a network capable of providing communications between said one or more manufacturers and one or more user sites associated with each user, said user site including an input device and a display device, said system comprising:
a system server;
a web site coupled to said server and accessible from said one or more user sites via said network;
a database for storing transformer manufacturer design data for use by a user in designing a transformer to specific design requirements and for storing transformer pricing data for use in producing a price quotation based on a transformer design designated by said user;
a display means on said web site for causing transformer design data of at least one of said one or more manufacturers to be represented on said display device;
a product configuration means on said web site for use by said user in designing a transformer by selecting said transformer design data displayed by said display means using said input device to configure said transformer;
a product description means on said web site for displaying to said user a product description resulting from product configuration means, said product description including a calculated performance characteristics and a list of mechanical and electrical features; and
a pricing means on said web site for calculating a price of said transformer designed by said user, wherein said calculated price and said product description are displayed to said user on said display device via said web site.

2. The system of claim 1, further comprising a product ordering means on said web site for use by said user in entering an order for said transformer using said input device after reviewing said product description and said calculated price of said transformer.

3. The system of claim 2, wherein said order for said transformer is received by said server and forwarded to said selected manufacturer for manufacturing of said transformer in accordance with said product description.

4. The system of claim 1, wherein said database further stores customer identification information indicative of a customer's identity, location, and billing policy, wherein said user can access said customer identification information in said database and make a single selection via said web site which thereby incorporates all of said customer identification information into said order.

5. The system of claim 1, wherein said product configuration means further comprises a form-based menu and said design specification data represented on said display device further comprises one or more of predefined product specification data and a selection of options from a predefined set of choices that are accessible via said form-based menu using said input device.

6. The system of claim 5, wherein selection of one of said predefined product specification data results in incorporation of all of said manufacturing design specification data into said product description and said product pricing.

7. The system of claim 1, wherein said system further comprises an order editing means for use by said user in changing a previously entered transformer order via said web site using said input device.

8. The system of claim 1, wherein said wherein said system further comprises an order statusing means for use by said user in accessing said system to obtain a status of a previously entered transformer order at said display device.

9. The system of claim 1, further comprising a manufacturing bill of materials generated by said product configuration means.

10. The system of claim 1, wherein said system further comprises a shopping cart means for use by said user in adding one or more ordered items to said shopping cart.

11. The system of claim 1, wherein said shopping cart means further comprises an upper level displayed to said user on said display device and a lower level which is not displayed to said user at said display device, said upper level comprising a price, a quantity, a product identification number, and a delivery lead-time of said designed transformer, and said lower level comprising a bill of materials and mechanical and electrical performance data specific to said designed transformer.

12. The system of claim 1, further comprising a drawing development means on said web site for creating drawings on said server depicting said designed transformer.

13. The system of claim 12, wherein said drawings can be downloaded to said remote user site and can be communicated to said manufacturer of said designed transformer.

14. The system of claim 1, wherein said product pricing means further comprises a cost associates with a bill of materials, a manufacturing cost, and a suggested selling price for said transformer configured by said user.

15. A method for creating an on-line request for quote for a distribution transformer comprising the steps:
providing a server accessible by a user from a remote location for receiving a request for quote from said user, receiving customer data into said server;
receiving ship to information for said customer into said server;
providing terms relating to terms of sale for selection by said user relating to said request for quote;
providing notes relating to different stages in completing said request for vote for selection by said user for attachment to said request for quote;
providing a shopping cart to which said user may add one or more items selected for said request for quote;
providing a designing server accessible by said user from a remote location for designing a transformer in accordance with said request for quote;
providing one or more manufacturer design specifications for use by said user in designing said transformer;
generating a bill of materials and a transformer description in accordance with said request for quote for said designed transformer, calculating a manufacturing cost for said transformer based on said bill of materials; and
displaying said customer request for quote at said remote location.

16. The method of claim 15, further comprising the step of receiving an order from said user for said transformer into said server.

17. The method of claim 16, further comprising the step of forwarding said order for said transformer from said server to a manufacturer of transformers for manufacturing of said transformer in accordance with said bill of materials and said transformer description.

18. The method of claim 15, wherein said request for quote received from said user comprises one of a new request for quote and an existing request for quote previously entered into said server.

19. The method of claim 15, wherein said method further comprises the step of creating drawings on said server based of said bill of materials and a transformer description, said drawings being adapted for download to said user's remote location and for attachment to said request for quote.

20. The method of claim 15, wherein said step of providing a designing server accessible by a user from a remote location for designing a transformer further comprises designing and defining items according to predetermined manufacturing specifications including adding accessories and optionally selecting a core and coil.

21. The method of claim 15, further comprising the step of storing said customer data and said transformer manufacturer design data in a database that is accessibly from said server for use by said user in completing said on-line request for quote for said transformer.

22. The method of claim 15, further comprising the step of checking a status of a previously submitted request for quote from said remote location.

23. The method of claim 15, wherein said step of providing a designing server further comprises the steps of providing a first parts selection menu for use by said user in selecting internal accessory parts independent of said core and coil, providing a menu for selecting a coil and coil, and providing a second parts selection menu for use by said user in selecting external parts for packaging said core and coil.
